(19) United States
(12) Patent Application Publication
(10) Pub. No.: US 2013/0144794 A1
(43) Pub. Date: Jun. 6, 2013

(54) SYSTEM AND METHOD FOR MULTI-USE IDENTIFICATION DEVICE

(71) Applicant: Beverly Ross Denny, Milton, MA (US)

(72) Inventor: Beverly Ross Denny, Milton, MA (US)

(21) Appl. No.: 13/774,374

(22) Filed: Feb. 22, 2013

Related U.S. Application Data
(63) Continuation of application No. PCT/US2012/028713, filed on Mar. 12, 2012.
(60) Provisional application No. 61/451,779, filed on Mar. 11, 2011.

(51) Int. Cl. G06Q 10/06; H04L 29/06

(52) U.S. Cl. 705/76; 235/375

(57) ABSTRACT

A multi-function identification device (ID) provides identifying information for the person to whom the ID was issued, as well as providing machine readable indicia for conducting a transaction. The ID may be a card issued by a government agency such as a driver's license or identification card. The transactions may be conducted with one or more accounts or value amounts identified using the machine readable indicia. Credit, debit and pre-paid accounts can be accessed for transactions using the machine readable indicia. Value amounts can be read and modified using this enhanced card that implements the machine readable indicia. The user can select the functionality to be added to the ID, which can optionally be used in conjunction with the identifying information to help verify identification. The machine readable indicia can be integrated in a new ID, or applied to an issued ID using an appliqué.

### CROSS-REFERENCE TO RELATED APPLICATIONS

This application is a continuation of International Application No. PCT/US2012/028713, filed Mar. 12, 2012, which claims the benefit of U.S. Provisional Application No. 61/451,779, filed Mar. 11, 2011, the entire contents of each of the above disclosures being hereby incorporated herein by reference.

### STATEMENT REGARDING FEDERALLY SPONSORED RESEARCH OR DEVELOPMENT

N/A

### BACKGROUND OF THE INVENTION

The present disclosure relates generally to multipurpose identification devices, and more specifically to identification devices used to perform financial transactions.

Traditionally, state-issued identification cards (IDs) are used simply for identification in a limited number of settings such as:
a. identifying the person to whom the card was issued
b. determining eligibility to operate a motorized vehicle and under what restrictions
c. determining legal eligibility to purchase alcoholic beverages or other controlled substances

The state-issued ID is typically universally accepted as a legal form of identification and is ubiquitous amongst adults aged 18 and over.

The state agency issuing the ID is typically a registry or department of motor vehicles operating under the auspices of a state. The state agency typically has a process in place to ensure that the information used to create and distribute an ID is collected at the time a consumer requests an ID card. The state agency collects and ensures the accuracy of the personal information provided at the time the request is made for the ID. For example, the state agency may request additional forms of identification, such as a social security card, birth certificate, passport, or other proof of identification of the consumer requesting the ID. In addition, a photograph of the user is typically taken and stored to be later associated with and printed upon the ID.

The state agency may take further steps to help ensure the authenticity of the ID. For example, some states may issue IDs that include ghost images, laser perforations and UV printing amongst other tools to ensure the authenticity of the ID when it is rendered. Once the consumer information is obtained and verified, and the content and form of the ID is determined, the state-issued ID is typically printed and distributed to the consumer.

While the state-issued ID has the capacity to be used for more than identification purposes, to date, there is no system or process by which the state issuing agency can add further functionality to the card to facilitate financial transactions.

Financial institutions have issued credit and debit devices, such as magnetic strip cards, contactless smart cards, and/or other proximity active or radio wave active devices, as their own provider or through a third party provider to facilitate financial transactions. These devices are typically implemented with machine readable indicia, such as a magnetic strip, radio wave responsive circuitry, barcodes or other information storage arrangements that can store value amounts and/or account information for the consumer to which the device is issued.

The magnetic strip on a card, as an example of a popular and ubiquitous implementation of a device to facilitate financial transactions, can be read by a magnetic strip card reader typically located at a point of sale (POS) to permit the consumer to purchase items based on credit extended or account value maintained by the financial institution that issued the card. These financial institutions typically wish to ensure the security of these devices and have implemented various technologies to verify that the devices are used only by authorized persons such as the person to whom the device was issued. Such secure technologies include pin numbers, smart card chips, four-digit security codes and other authentication technology. While these technologies are ubiquitous, financial transaction and identity theft related fraud remains a problematic issue.

### BRIEF SUMMARY OF THE INVENTION

The present disclosure provides systems and methods for adding functionality to an identification device to facilitate financial transactions, e.g., credit purchases, debit purchases, electronic account access, increasing or decreasing account amounts, public transportation payment, point of sale (POS) payment, and any other type of financial transaction that can be accomplished using an account or value presented via an identification device and machine readable indicia associated with the identification device. Examples of such machine readable indicia includes, but is not limited to, barcodes, two dimensional barcodes, QR codes, magnetic strips, smart cards, RFID devices or any other machine readable technology that can be added to an identification device (ID), such as an identification card, and in particular, a government-issued ID. The ID may, for example, be a government-issued ID, implemented on a substrate, such as a plastic state-issued driver's license or identification card.

Linking a government-issued ID to one or more accounts, such as might be associated with a credit or debit card, can provide additional security to the consumer and financial services industry because of the safeguards integrated into the combination card.

According to an aspect of the present disclosure, a government agency responsible for issuing IDs collects and maintains information related to consumers that request IDs. When requesting or applying for an ID, the consumer typically submits personal information related to identity, which personal information can be verified by the government agency, typically in the form of document that is deemed to provide acceptable identifying information. Such documents may include, for example, a birth certificate, passport, social security card, or other documents that might be deemed acceptable for identification, such as the documents or combination of documents listed on an I 9 form available from the U.S. Citizenship and Immigration Services agency.

Upon presentation of acceptable forms of identification, the consumer's private information is typically stored in a database maintained by the government agency responsible for issuing IDs. The database entries for consumers can be used to establish or link accounts with institutions or entities that may offer products or services that depend on some financial transaction. For example, the institution may be a credit card company, a bank, a transit authority, a retailer, a service provider, another government agency or department, or any other type of entity that may offer credit, maintain accounts or provide other infrastructure for facilitating financial transactions.

According to an aspect of the disclosure, the consumer has a pre-existing account that can be linked to the ID upon application for the ID. An identifier for the pre-existing account can be provided to the ID, so that financial transactions using the ID access the pre-existing account using the identifier. In accordance with this aspect, the entity that maintains the pre-existing account can authorize the government agency to create an ID with the identifier. The government agency or a third party provider, collectively referred to herein as a provider or service provider, may issue the ID with the identifier in machine readable form to permit machine actuated financial transactions to be implemented. An implementation according to this aspect may maintain separate databases, such as one or more databases maintained by the government agency to establish and maintain identification information, and one or more databases maintained by the entity to establish and maintain account information. The identifier may be an account number, such as a credit card number, for example, that is read by a machine connected to a network and provided to the entity for notice and verification of the transaction. In addition, a government agency-issued identifier might be provided to the entity to contribute to verification of identity during the transaction.

According to another aspect of the disclosure, the consumer may have an account initiated by the government agency, in accordance with pre-existing agreements with financial transaction infrastructure providers. For example, the application for a state-issued ID may include an application for an account with a credit provider. Upon approval of the application by the credit provider, the state agency may cause an ID to be issued to the consumer that includes an identifier for the new account. In this instance, the state agency, credit provider or a third party may host a shared database or databases that include information related to the identity of the consumer and account information for the consumer related to the credit provider.

According to another aspect of the present disclosure, the consumer may select from among several available functions to be added to the ID. The available selections may include new or existing credit, debit or pre-paid accounts, value storage or particular types of identification acceptable at predetermined locations, such as may be used to access locations that are restricted from general public access. Several function selections can be added to ID using one or more machine readable indicia or technologies. The IDs also need not be issued on behalf of a government entity, but can be issued by private or public entities for such purposes as gaining admission to a public or private event or service, such as may be used for air travel or attending a sporting event.

According to another aspect of the present disclosure, the government-issued ID may provide identification information to a machine or to an operator at a transaction point to permit the identity of the consumer to whom the ID was issued to be verified. For example, the ID may provide an image or other identifying indicia to the machine, which the machine or operator may use to verify that the individual using the ID is the same as the consumer to whom the ID was issued. The transaction may be conditioned on verification of identity to a certain threshold to mitigate attempts at fraud or identity theft.

According to another aspect of the present disclosure, the consumer may apply for an ID that can be issued by the government agency to include a value measure in the ID itself. For example, the state agency responsible for issuing IDs may issue a smart card that can store information that represents value, such as cash value or consumer point program value, such as is often used in a consumer rewards program. The information can be modified using a smart card interface at a transaction location, such as might be available at a turnstile or other transactional suitable points, to add or subtract value from the smart card. In the present disclosure, any type of value, including cash or credit equivalents, points in a rewards program, indicia of progress in a program or of accumulation of products, services or events, is referred to herein in the context of a financial transaction.

According to another aspect of the disclosure, the consumer is presented with a choice of functionality to be provided to an ID. The choice of functionality may be the linking of an account, the establishment of an account and/or the provision of value storage to the ID. The functionality may be provided by issuance of a new ID with the additional functionality, or by issuance of a component to be applied to an existing ID to add the chosen functionality. For example the ID may be provided with machine readable indicia upon being created, or machine readable indicia may be applied to the existing ID, such as with an appliqué, to provide the desired functionality.

According to one embodiment, a state government issues IDs with capability for financial transaction. The state government may provide the service themselves or outsource this work to an external provider. The state government may reissue a new ID pre-programmed with machine readable technology that stores account information (e.g., magnetic strip, computer chip or bar code) or may send the consumer an appliqué to place on the card that has been pre-programmed with the above mentioned machine readable technology. In either case, the issuing agency or contracted external provider would fulfill orders for IDs that are linked to a pre-paid account or the user's personal credit or debit accounts. The issuing state government may provide the means for a consumer to make the choice of how the machine readable technology is implemented on the state issued ID.

When a consumer decides they would like to add the functionality to complete financial transactions with a state issued ID, they can make a request directly to the state issuing agency (e.g., Registry or Department of Motor Vehicles) or the external provider to which the state has contracted to complete the transaction. The agency or external organization creating the card is referred to herein as the provider. The provider may choose to receive these requests through multiple means, for example, the agency's offices, through postal mail, e-mail or via a website.

The provider may allow the consumer to select what type of account they would like to link to their government-issued ID. The user choices for linking can include a pre-paid credit account, pre-paid debit account, personal credit account or personal debit account. If the consumer selects to link the ID to a pre-paid account, they can select an account from a major card company (e.g., American Express, VISA, Mastercard). If the consumer chooses to link their ID to an existing personal debit or credit card account, they can specify which card they would like to link to by entering the appropriate account information.

The consumer can verify the credit or debit card account information to ensure its accuracy (e.g., by re-entering the account number). In addition, the provider managing the process can authenticate the account information to ensure the card is valid and that the consumer is the true account owner.

The provider can determine whether to issue a new ID or to issue an appliqué to be placed on an existing ID. The provider can program the machine readable technology to be used (e.g., magnetic strip, barcode or computer chip) with the pre-paid or personal card account information. Once the new ID or appliqué is created, quality control measures can be initiated to ensure the accuracy of the programmed information. The new linked government-issued ID or appliqué is delivered to the consumer, such as by being mailed or picked up by the consumer, depending on what the provider determines is appropriate or makes available.

### BRIEF DESCRIPTION OF THE SEVERAL VIEWS OF THE DRAWINGS

The systems and methods of the present disclosure are described below in greater detail with reference to the accompanying drawings, of which:

FIG. 1 is a flow chart illustrating an exemplary embodiment of a method for selecting additional functionality for a state-issued ID in accordance with the present disclosure; and

FIG. 2 is a flow chart illustrating an exemplary embodiment of a method for determining feasibility of and selecting additional functionality for a state-issued ID in accordance with the present disclosure.

### DETAILED DESCRIPTION OF THE INVENTION

This application claims the benefit of U.S. Provisional Application No. 61/451,779, filed Mar. 11, 2011, the entire contents of which are hereby incorporated herein by reference.

In accordance with the present disclosure, a user may request a government-issued identification device (ID) that has additional functionality determined by a selection made by the user. As used herein, the term “government” may include any form or level of government in a given jurisdiction, including international, national, state, county, city and local organizations responsible for governing the given jurisdiction. The provider of the government-issued ID may offer a number of additional functionality selections including, in addition to those mentioned above, membership accounts or indicators, vendor participation identifiers, such as may be provided for participation in a vendor discount program, for example, or any other type of additional functionality that can benefit from being able to identify the user with a relatively high degree of authentication through the government-issued ID application and issuing process.

The key feature of offering a variety of additional functionality with the government-issued ID permits the authenticated identification of the identified user with the selected functionality for machine readable transactions, based on the machine readable indicia available on the combination ID. By offering the variety of additional functionality the feature of being able to select from among different options or combination of options to obtain additional functionality for the ID provides unique advantages to the government, functional service provider and consumer, as well as the facility connected with the additional functionality. For example, a credit card company that permits credit accounts to be associated with a state-issued ID benefits from the potential for a greatly reduced incidence of fraud. The consumer benefits from reduced numbers of cards that are carried or presented to initiate or complete transactions. The government agency and/or provider responsible for issuing IDs benefit from being able to charge a fee for additional services provided with the issued ID. In addition, the selection process can be implemented on a flexible basis, such as through postal mail, e-mail or web site access and selection.

The government-issued ID with the machine readable indicia is used by the individual identified by the ID to perform additional functions beyond identification or licensure by having a machine, such as a barcode reader, magnetic strip reader, RFID reader, smart card reader or any other type of machine readable indicia reader, read the machine readable indicia to obtain the information contained in the machine readable indicia. In addition, or alternately, the machine readable indicia may be modified to update a value parameter stored with the ID. Such a value parameter may represent cash, credit or participant program value, which can be read, increased, decreased or otherwise adjusted in accordance with a transaction conducted by the consumer.

The information obtained with the machine readable indicia can be used to perform a lookup of account information, for example, to implement a transaction on the account. In this way, a credit, debit, membership or other type of transaction can be applied to the relevant account. The machine readable indicia may also include information about the individual identified in the state-issued ID, such as name, address, license number or other identifying information as obtained and used by the state government in issuing state-issued IDs. In this way, a transaction can be implemented for an account identified by the machine readable indicia, with additional authentication of the user's identity and authorization for account transactions.

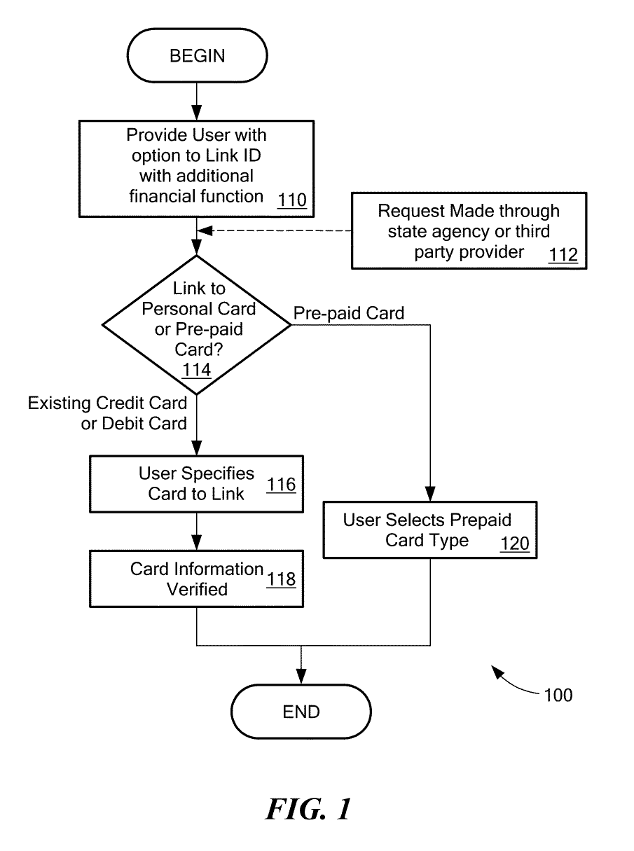

Referring now to FIG. 1, a process 100 for providing an enhanced functionality ID is illustrated. A consumer or user is provided with the opportunity to link a government-issued ID with a financial transaction function, as illustrated in block 110. The consumer can submit a request or make an application to the entity responsible for issuing IDs as illustrated in block 112. For example, the consumer may submit a request directly to a state agency such as a registry or department of motor vehicles or to a third party provider that has been contracted by the state to complete the transaction. The agency or third party provider that creates the ID may choose to receive these requests through multiple means, for example, the agency's offices, through postal mail, e-mail or via a website.

The agency or provider may offer options for the consumer to permit selection of an account or service to be linked to the ID. Some of the choices may include linking to a pre-paid credit account, pre-paid debit account, personal credit account or personal debit account, for example. Other services or account links may also be implemented, using available machine readable/writeable technology, such as magnetic strips, barcodes, smart cards, RFIDs, or other techniques that may permit the linkage of services or accounts with the ID. Decision block 114 illustrates at least one choice between a personal account, such as a credit or debit account, and a pre-paid value or account.

If the consumer selects to link the ID to a pre-paid account, as illustrated in block 120, a selection of account from major credit card companies can be provided, such as a selection of American Express, VISA or Mastercard, for example. If the consumer chooses to link the ID to an existing personal debit or credit account, as illustrated in block 116, the account can be specified by entering the appropriate account information. The consumer can verify the credit or debit account information to ensure its accuracy, such as by being asked to re-enter the account number. In addition, the agency or provider managing the linking process can authenticate the account information to ensure the card is valid and that the consumer making the request is the true account owner, as illustrated in block 118. One way in which the agency or provider can verify the consumer's identity is through the information available from the government for issuing IDs. For example, the government agency or provider that issues IDs typically maintains consumer information related to identification. This information can be used to verify identity during the linking process, in addition to using identity information that may be available from a credit or debit account provider.

The agency or provider may issue a new ID with the added functionality to the consumer, or may issue an appliqué to be placed on an existing ID. The new linked ID or appliqué is then delivered to the consumer, such as by being mailed or picked up by the consumer depending on what the agency or provider determines is appropriate or makes available.

The added functionality provided to the ID may be in the form of machine readable indicia, which type of indicia may depend on the service or account linked to the ID. For example, a transportation payment service may be implemented with a smart card value linked to the ID, so that the multifunction ID can be used with a tap pad or smart card reader located at an entrance to the transportation service. The tap pad or smart card reader can deduct the value of the transportation service from the value in the multifunction ID, optionally while permitting verification of identity. Verification of identity may be obtained by an operator examining the ID and the consumer to ensure no fraudulent use of the ID. The smart card reader may provide an image of the consumer to which the multifunction ID was issued to permit verification of the identity of the user.

With respect to a government-issued ID, some infrastructure issues that the present disclosure addresses include assessing legal feasibility for the government agency, as well as assessing any current agreements with third party providers that may be responsible for contributing to issuing state-issued IDs.

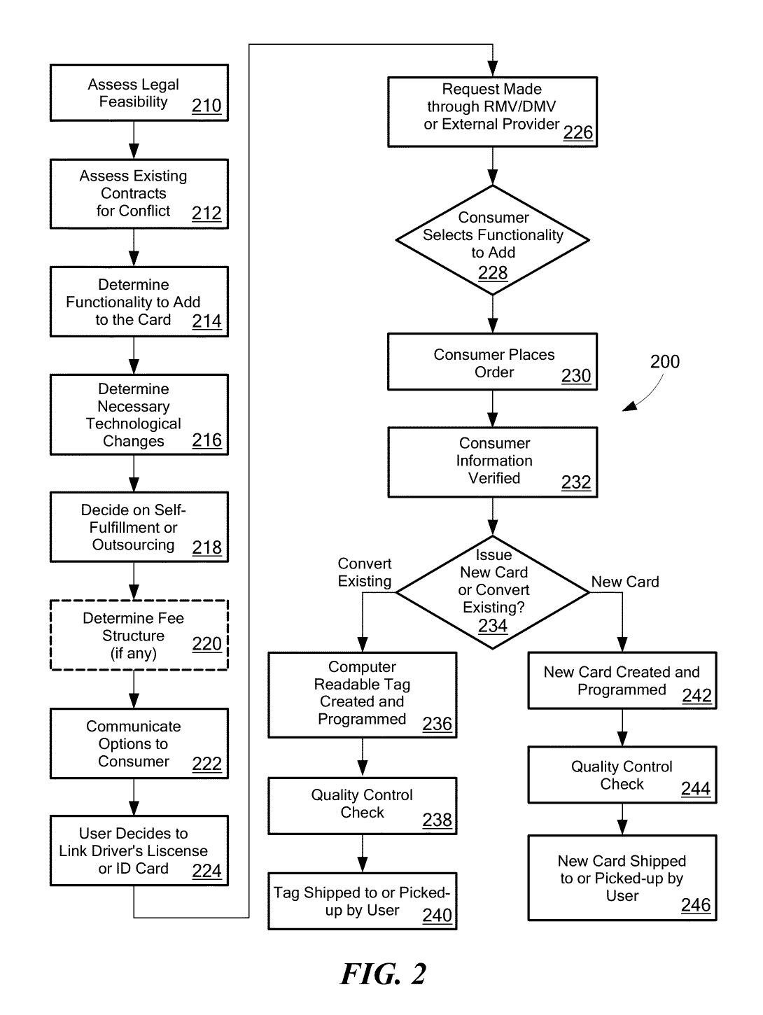

Referring to FIG. 2, a government agency, such as a state agency, may use all or some of the methods or steps described below, where the order presented in the following description need not be the order in which a method or steps are executed in accordance with the present disclosure. One issue addressed by the present disclosure is the determination or assessment of legal feasibility for the government agency to implement a transaction-capable ID, as indicated in block 210. For example, each state may have state-specific laws governing the purpose and use of a state issued identification card. Before embarking on adding functionality to the card, research of the current legislation may be undertaken to determine the legality of making such a change and assess whether or not legislative changes or action are necessary. If, for example, current state laws or regulations represent an obstacle to implementing a financial transaction capable state-issued ID, workarounds for implementing the ID in compliance with applicable law or regulations may be explored and used. Alternately, or in addition, state laws or regulations may be amended or modified to permit the functionality for financial transactions to be applied to the state-issued ID.

The present disclosure also addresses the issue of whether the addition of financial transaction functionality to the state-issued ID would conflict with contractual obligations of the state or state agency, as indicated in block 212. For example, the state agency responsible for issuing IDs may have existing agreements in place that may conflict with the option to add functionality to the state-issued ID. For example, there may be an existing agreements in place with a vendor that manufacturers and distributes state-issued IDs.

In such an event, a determination or assessment can be made as to whether adding functionality to the state-issued ID would be in conflict with existing agreements. If any conflict risks are identified, or if the economics of breach of contract warrant, steps can be taken to modify the contract terms, obtain a release of the contract or terminate the contract to reduce the risk or penalty of adding functionality to the state-issued ID. If no conflict is apparent, the state agency can plan to implement the added functionality for the state-issued ID.

Before, during or after the legal or contractual issues involved in permitting a state agency to add functionality to a state-issued ID are resolved, the state agency may determine the functionality to be made available with the state-issued ID, as illustrated in block 214. The state agency responsible for issuing state IDs may determine the functionality to be added to the ID solely, or in conjunction with other government agencies or consumer constituencies. For example, the state agency may independently determine the functionality to be included, such as, e.g., access to a public transportation network, pre-paid value, credit provisions, or any other capability for realizing a financial transaction.

The state agency may consider issuing a request for proposal to assess third-party interest, for example to determine a level of interest on the part of credit providers, pre-paid credit providers, debit transaction providers or suppliers of devices, such as cards, for implementing these types of transactions. The state agency may also assess the feasibility or interest on the part of other government agencies that deliver services on behalf of the government. For example, government assistance programs such as social security, electronic benefits transfer (EBT), food stamps or other programs that provide services that may benefit from inclusion of identification in exchange for receiving services may use the features of the present disclosure.

The government, or state, agency responsible for issuing the IDs with added functionality may process the IDs itself, including manufacture and distribution of the IDS. Alternately, or in addition, the government may permit third parties to process the IDs, in whole or in part, and function as service providers in conjunction with the use of the government-issued ID. As discussed herein, the government or third party providers that produce the enhanced or multifunction IDs are collectively referred to as providers or service providers. Third parties may be selected through usual government selection processes, such as bidding selection, request for proposals (RFPs), or other formal procurement process required or established by the government. Other government agencies or departments may choose to leverage the government-issued ID or issuing process to contribute to identifying program participants, administration of benefits or other agency activities that would benefit from the features of the present disclosure. In one aspect, the government agency or department can act as a sole source provider of the services offered.

The government agency responsible for issuing IDs may determine how or what machine-readable technology may be used for implementing additional functionality, as indicated in block 216. For example, machine readable technology that stores account information, such as with a magnetic strip, a smart card chip and circuitry or a bar code, as examples, can be incorporated into the state-issued ID to facilitate delivery of or access to the aforementioned services. The functionality incorporated into the state-issued ID may be matched with a particular machine readable technology to facilitate use of the functionality in conjunction with the identification features of the ID. For example, smart card technology may be used for storing value that can be modified with a tap pad or other smart card interface implemented for public transportation. Magnetic strip machine readable technology may be used for read-only access of an account number to conduct credit or debit transactions involving government assistance programs, as may be useful at ubiquitous point of sale (POS) devices that provide magnetic strip readers to facilitate financial transactions. In any event, the ID may use or incorporate machine readable functionality to identify users and/or to track service usage/provision to facilitate financial transactions.

The determination of the machine readable technology to be used may also be dependent on, or take advantage of, various modes of implementation of the machine readable technology. For example, the issuing government agency can determine if the machine readable technology is to be applied to an ID by issuing or reissuing the ID. The government agency can choose to provide an appliqué to be affixed to the existing state issued identification card, such as by an adhesive or other attachment/affixing means. The government may also permit a consumer to choose how the machine readable technology is implemented on the government-issued ID. For example, the government may provide several options for implementing the additional functionality with the ID, and permit the consumer to choose among the options. According to an exemplary embodiment, if the consumer can access a new or existing personal credit account or pre-paid account, the service provider may use or add a pre-programmed magnetic strip or chip to the government-issued ID to facilitate financial transactions.

In accordance with an exemplary embodiment, an existing state-issued ID number may be used, both for identifying the consumer and for identifying one or more consumer accounts. For example, a financial institution or third party provider may choose to use an existing identification number implemented in a magnetic strip or bar code on the state-issued ID as the consumer's account number to perform financial transactions or access services, such as, for example, food stamps, gym membership and other actions as discussed in the present disclosure.

Another issue that the present disclosure addresses is the source for the multifunction government-issued ID, as illustrated in block 218. The government can be internally responsible for the processing and fulfillment of the multifunction government-issued IDs, or may select a third party provider to undertake and fulfill some or all of the components of producing the multifunction IDs. The government may examine a number of considerations that may be involved in a decision as to whether the provision of additional functionality to government-issued IDs is to be undertaken by the government or a third party. Some such considerations include the scope and scale of such a project, privacy considerations, efficiencies available according to industry practices, such as the infrastructure for manufacturing cards that may be available to third parties, ease of access and use by consumers, as well as other considerations that may influence the ID provisioning process.

If the government retains the option to perform all or a portion of the work, internal resources may be added or re-tasked to permit implementation of the project. The government may choose to add resources to complete the work or reassign existing resources. If the government chooses to outsource all or a portion of the work, procurement guidelines for identifying, selecting and engaging a vendor to provide the services on behalf of the government may be engaged to permit equitable selection of a third party, such as, for example, requests for proposals or other procurement processes used to procure goods or services for the government.

As part of the provisioning process for producing a multifunction ID, the government may charge a fee, as indicated in block 220. The fee may be considered a source of revenue for the government, or may be incurred as a result of offering services of a financial institution in conjunction with the ID, for example. The government may choose to charge a one-time or ongoing fee, and can condition the fees and fee schedules on the services offered in conjunction with the ID. The government may also charge a fee to other government agencies or departments, or to third parties, for providing access to the government-issued ID, or to the data associated with the IDs. Some examples of income sources include:

i. Consumer usage fee: consumers may pay the government a flat one-time or recurring fee for the use of the ID.

ii. Third party access fee: third parties interested in utilizing the ID may pay a flat fee, a per user fee, value of transaction fee, revenue sharing or any combination of these options to the government.

iii. Per usage fee: the government may receive a fee as a portion of the transaction value every time the ID is used. For example, a consumer utilizing their ID when accessing a public transportation system can be charged a per use fee for accessing the network and a portion of the payment can be remitted to the government.

The government, or outsourced entity, as service provider, may also determine how the ID will be made available to consumers, as indicated in block 222. According to an exemplary embodiment, the service provider issuing the ID may offer the multifunction addition to a select subset of consumers, such as those that use a particular service or program of the government. The provider can communicate the availability of the ID enhancements and the available options to consumers through various selected channels.

In addition, the provider can offer one or more facilities for requesting the enhanced ID, as well as for providing payment for the ID. The consumer can use such facilities to decide to link the ID with another function, such as may facilitate conducting financial transactions, as illustrated in block 224. The provider can present consumers with options that are available with and how to request the enhanced ID. The service provider may choose to receive consumer requests through various channels as well, such as, for example, the agency's offices, through postal mail, e-mail or via a website. For example, an agency such as the Department of Motor Vehicles may make brochures or entries available with registration forms that describe the services and options available, and can offer a form for the consumer to fill out to apply or place an order for an enhanced ID. Orders can be placed on-site and, if desired, payment accepted for an enhanced ID, as illustrated in block 226.

Alternately, or in addition, a website can be made available for consumers to learn more about the offered services, review the available options, and/or accept orders and/or payment for the enhanced IDs, as illustrated in block 228. The consumer places the order with the provider as illustrated in block 230. Depending upon the services the consumer chooses to link to the ID, additional information may be obtained from the consumer at the time of order. In addition, the provider managing the process may request information to authenticate the user and account information, as is illustrated in block 232. For example, if the consumer selects to link the ID to a pre-paid account, a selection can be provided for choosing a major credit card company, such as American Express, VISA or MasterCard. Other selections can be provided to identify a credit card with which to reload the pre-paid account.

If the consumer chooses to link the government-issued ID to an existing personal debit or credit account, they can specify which card they would like to link to by entering the appropriate account information. Once a consumer places an order for the enhanced ID, the responsible service provider creates the ID or appliqué that is to be sent to the consumer.

The agency, third party provider or consumer may choose to issue a new ID with the added functionality, or to convert an existing ID to include the added functionality, as illustrated in decision block 234. The choice of how the functionality is to be added may be made contingent upon the fees charged to issue a new ID or to modify and existing ID.

In some instances, the service provider may offer a limited choice of whether a new or updated ID will be issued, which may be contingent on the functionality to be added as selected by the consumer.

If a new ID is to be provided, the provider may reissue an ID as a multifunction or enhanced ID that is linked with a financial transaction capability, as illustrated in block 242. For example, the ID can be implemented to have machine readable indicia that stores relevant account information. Some examples of such indicia include magnetic strips, smart card chips and circuitry and barcodes. If the ID is to be modified or converted to include the additional functionality, a pre-programmed appliqué to can be created for application to the ID, as illustrated in block 236. The appliqué includes machine readable indicia, and is configured to be affixed to the ID such as with adhesive or other fasteners.

Once the new enhanced ID or appliqué is created, quality control measures can be initiated to ensure the accuracy of the programmed information relative to the order, as is respectively illustrated in blocks 238 and 244. The quality control measures may call for emulation of a transaction permitted by the additional functionality, to verify proper operation. The consumer's new linked ID or appliqué is delivered to the consumer, as is respectively illustrated in blocks 240, 246. The enhanced ID or appliqué can be mailed directly to the consumer or delivered to the government agency or third party provider and picked up by the consumer.

It should be emphasized that the above-described embodiments of the present invention are just possible examples of implementations, merely set forth for a clear understanding of the principles of the invention. Many variations and modifications may be made to the above-described embodiments of the invention without departing from the spirit and principles of the invention. All such modifications and variations are intended to be included herein within the scope of this disclosure and the present invention and protected by the following claims.

What is claimed is:

1. A computer implemented method for a government agency responsible for licensure to issue to a user a personal identification device (ID) that includes transactional functionality, the method comprising:
storing personal identification information related to the user in a computer storage system;
assigning to the personal identification information a government agency specified identifier that is unique to the personal identification information for the government agency;
providing the user with a plurality of options related to transactional functionality that can be included with the ID;
receiving an indication of a selection by the user of at least one of the plurality of options;
obtaining an account identifier associated with the selection by the user in accordance with the indication, the account identifier providing access to the transactional functionality;
forming a first machine readable indicia that is non-human readable and that includes a representation of at least some of the personal identification information, including the government agency specified identifier;
forming a second machine readable indicia that is non-human readable and that includes a representation of the account identifier;
forming the ID with the first and the second machine readable indicia, whereby the first machine readable indicia is readable by a first machine to obtain the government agency specified identifier to permit identification of the user, and the second machine readable indicia is readable by a second machine to obtain the account identifier to permit a transaction to be undertaken in accordance with the transactional functionality.

2. The method according to claim 1, wherein the first and the second machine readable indicia are one and the same, and the first and the second machines for reading the first and the second machine readable indicia are one and the same.

3. The method according to claim 1, further comprising delivering the ID to the user.

4. The method according to claim 1, further comprising providing one or more of a barcode, a magnetic strip or a smart card computer chip as the first or the second machine readable indicia.

5. The method according to claim 1, further comprising providing the user with the plurality of options related to transactional functionality of a credit account, debit account, pre-paid account or stored value.

6. The method according to claim 1, further comprising the government agency collecting the personal identification information.

7. The method according to claim 1, further comprising providing the user with the plurality of options related to transactional functionality via a third party service provider.

8. The method according to claim 1, further comprising tracking usage of the ID in undertaking the transaction.

9. The method according to claim 1, further comprising integrating the first and the second machine readable indicia into the ID.

10. The method according to claim 1, further comprising forming an appliqué suitable for being affixed to the ID and including the first and the second machine readable indicia.

11. The method according to claim 1, further comprising the second machine reading the second machine readable indicia to contribute to undertaking the transaction.

12. The method according to claim 11, further comprising collecting a fee when the transaction is undertaken.

13. A multi-function identification device (ID), comprising:
an ID substrate suitable for being provisioned with machine readable indicia;
a first machine readable indicia, which is non-human readable, and which stores transaction functionality related information, being applied to the substrate and providing the transaction functionality related information upon being read by a first machine to permit a transaction to be undertaken;
a second machine readable indicia, which is non-human readable, and which stores personal identification information, being applied to the substrate and providing the personal identification information upon being read by a second machine, the personal identification information including a representation of a personal identifier associated with the personal identification information; and
the transaction functionality related information including at least one account identifier and being selected based on a plurality of options presented to the user for transaction functionality for inclusion in the first machine readable indicia.

14. The ID according to claim 13, wherein the first and the second machine readable indicia each further comprises one or more of a barcode, a magnetic strip or a smart card computer chip.

15. The ID according to claim 13, wherein the ID substrate further comprises a plastic card.

16. The ID according to claim 13, wherein the first and the second machine readable indicia are one and the same.

17. The ID according to claim 13, wherein the ID is issued by a government agency responsible for licensure, and the personal identifier is a license number.

18. A computer implemented method for an entity to issue to a user a personal identification device (ID) that includes transactional functionality, the method comprising:
assigning a personal identifier to the user that is unique within the issuing entity;
providing the user with a plurality of options related to transactional functionality that can be included with the ID;
receiving an indication of a selection by the user of at least one of the plurality of options;
obtaining an account identifier associated with the selection by the user in accordance with the indication, the account identifier providing access to the transactional functionality associated with the selection by the user;
forming a first machine readable indicia that is non-human readable and that includes a representation of the personal identifier;
forming a second machine readable indicia that is non-human readable and that includes a representation of the account identifier;
forming the ID with the first and the second machine readable indicia, whereby the first machine readable indicia is readable by a first machine to obtain the personal identifier to permit identification of the user, and the second machine readable indicia is readable by a second machine to obtain the account identifier to permit a transaction to be undertaken in accordance with the transactional functionality selected by the user.

19. The method according to claim 18, wherein the entity is a government agency responsible for licensure.

20. The method according to claim 18, wherein the first and the second machine readable indicia are one and the same.
